(19) United States
(12) Patent Application Publication
(10) Pub. No.: US 2003/0117612 A1
(43) Pub. Date: Jun. 26, 2003

(54) Dispersion measurement using a two-colour signal with ber/eye opening response

(75) Inventors: Mark Stephen Wight, Ottawa (CA); Chung Yu Wu, Kanata (CA); Andreas Franz Ludwig Sizmann, Ottawa (CA); Alan Glen Solheim, Stittsville (CA)

Correspondence Address: Hayes, Soloway, Hennessey,, Grossman & Hage P.C., 130 W. Cushing Street, Tucson, AZ, 85701, US

(73) Assignee: Innovance Networks

(21) Appl. No.: 10/036,662

(22) Filed: Dec. 21, 2001

(51) Int. Cl. G01N 21/00

(52) U.S. Cl. 356/73.1

(57) ABSTRACT

Dispersion is measured for an end-to-end link using two carrier wavelengths with a phase-synchronized signal modulated on each, and a single receiver that detects the BER of the combined fields. The power ratio of the two fields is chosen such that the weaker field modulates the eye of the stronger field, leading to slight periodic eye closure BER(τ)≅BER(τ+T_{B}) whenever the relative group delay changes by the bit period T_{B}. The magnitude of the relative group delay can therefore be inferred from the undulated BER response as a function of the wavelength detuning. A fit function is selected for the group delay response and the dispersion parameter D and dispersion slope S are calculated from this fit function after the function parameters are determined.

### FIELD OF THE INVENTION

The invention resides in the field of optical telecommunications networks, and is directed in particular to dispersion measurement in optical networks.

### BACKGROUND OF THE INVENTION

In optical transmission systems, the user traffic is carded by one or more channels traveling between a transmitter and a receiver in optical format. The receiver task is to convert the optical signal back into an electrical format and to extract the user signal. A channel is defined as a carrier wavelength modulated with user signal. Ideally, a light pulse (representing a digital “1”) is a surge of light of a certain power at wavelength λ0; in fact, the pulse of light has a certain “width” comprised of a small range of wavelengths about the central wavelength, so that a channel has a certain width as shown in FIG. 1A.

The optical fibers used as the transmission medium in most optical communication links and most optical components (optical amplifiers, filters), are dispersive, that is, different wavelengths of light travel at slightly different phase velocities vₚₕ=ω/k=c/n(λ), where c is the vacuum speed of light. The propagation characteristics of each wavelength depend on the effective mode index n(λ), or the effective propagation parameter k=2 πn(λ)/λ. The mode index changes with wavelength, polarization and mode profile, due to material dispersion and due to the waveguide dispersion of the confined mode. The effective mode index n(λ) shows a non-linear wavelength dependence over an extended spectral domain. As a result, not only the phase velocity, but also the group velocity v_{g}=δω/δk=c/[n−λ(dn/dλ)] changes with wavelength. The group velocity is the speed at which non-uniformities in the field intensity, such as an information-carrying modulated pulse train, move through the medium. However, an initially short pulse requires some spectral width as dictated by the fundamental property of Fourier transforms. As a result, the wavelength-dependence of the group velocity tends to broaden the pulse as it propagates through the fiber, because different spectral components of the pulse travel at different velocities.

This wavelength-dependence of the propagation parameter and consequently of the group velocity is termed chromatic dispersion CD, or intra-modal dispersion. FIG. 1B shows a signal ‘100101’ at the input of an optical link, and FIG. 1C illustrates how the light pulses representing the ‘1’ ‘widen’ as the signal travels down the fiber. As a result, the pulse energy of symbols “1” spreads into the neighboring symbols “0” (ISI or intersymbol interference), so that the receiver could interpret the signal correctly as ‘100101’, or erroneously as ‘100111’.

It is evident that reconstructing the user signal from the received optical pulses can pose problems, especially in WDM (wavelength division multiplexed) systems, where a plurality of channels travels over the same link.

The chromatic dispersion parameter D(λ) is defined as:

$$D ( λ ) = \frac{\partial τ}{\partial λ} \cdot \frac{1}{L} \qquad EQ 1$$

where δτ is the differential group delay (DGD) of two pulses, i.e. the variation of the travel time (in picoseconds) from the transmitter to the point of measurement, δλ is the differential spectral separation of the two carrier wavelengths (in nanometers) and L is the length of the fiber (in kilometers) over which the dispersion is measured. The dispersion is measured in ps/(nm km). For example, for every km of fiber traveled through, two pulses with a 1 nm initial separation of wavelengths will experience a differential group delay of 1 ps, if the dispersion of the fiber is 1 ps/(nm km). Similarly, the two outlying spectral components of a 10 Gb/s pulse with a 0.2 nm spectral width, will widen by a whole bit period (100 ps) after some propagation distance, and will then cause bit errors by spreading the pulse energy into the neighboring symbol.

Since the dispersion parameter D is wavelength-dependent, it may be approximated in the spectral domain around a center wavelength λ_{c} by:

D(λ)=D(λ_{c})+S(λ_{c})(λ−λ_{c})+½C(λ_{c})(λ−λ_{c})² EQ2

where S(λ_{c}) and C(λ_{c}) are respectively the dispersion slope and curvature at λ_{c}. The dispersion slope is given by:

S=δD/δλ EQ3

If we assume a linear dispersion slope, the slope can be expressed as the ratio of change in the dispersion to the change in the wavelength ΔD/Δλ calculated with respect to a reference wavelength.

Chromatic dispersion can be corrected, or “compensated,” through the use of specially designed optical components (such as fibers, Bragg gratings) inserted at given locations along the transmission path. For a comprehensive compensation, the dispersion of the compensating component (which could be packaged e.g. as a dispersion compensating module DCM) must be −D(λ), i.e. must have the same value, but opposite sign to the dispersion of the preceding transmission section.

With the data rates of optical communication systems increasing through techniques such as dense WDM (DWDM), and network reach increasing through techniques known as ultra long reach (ULR), determination of chromatic dispersion of the fiber and optical components within the systems becomes increasingly important. In ULR systems, the link dispersion is preferably compensated to have an optimal non-zero value (target value) on all links. Thus, dispersion of each transmission section needs to be determined with as much accuracy as possible to provide accurate compensation, for achieving longer un-regenerated reach and ultimately a less expensive network.

Fiber cable manufacturers provide chromatic dispersion coefficients by wavelength windows for each fiber cable type. Also, most device specifications include CD information. A simple way to determine the total dispersion over a link is to multiply the dispersion coefficient for a certain type of fiber by the fiber length in km and to add to this the specified dispersion of the optical components connected in the respective link.

This method is often used in current point-to-point networks, where each span/link is provisioned based on estimated data, using in addition generous engineering margins to ensure that the span/link will successfully carry the traffic over the specified distance. This is clearly not the best way of using network resources.

In addition, in many cases the fiber type is not known; there are no reliable methods to detect the type of the fiber buried in early days of the optical networking. Also, this method assumes a uniform dispersion along the entire fiber cable length, which is not generally true. While this assumption can be used in systems with a small channel-count and short links, it is not satisfactory for wavelength switched DWDM (dense WDM) systems.

A more accurate value of dispersion is evidently obtained by measuring the dispersion. Chromatic dispersion can be determined by performing time domain measurements and frequency domain measurements, as described for example by P. J Dean in “Optical Fiber Communications, Principles and Practice”, published in 1985 by Prentice-Hall International, Inc, London, pages 196-202.

However, current dispersion measurement methods can not be readily used in wavelength switched (agile) networks, for at least the following reasons.

a) The current networks have a point-to-point architecture that uses span equalization, so that the existing dispersion measuring methods can provide accurate dispersion measurements for a span, which is a relatively short lengths of fiber (100-150 km) and does not include optical amplifiers;

In wavelength switched networks (or agile network) a channel travels for much longer distances in optical format (without regeneration) than in point-to-point networks, passing through a plurality of optical amplifiers and intermediate nodes (switching nodes and/or optical add/drop nodes). Also, in optically amplified end-to-end links, amplified spontaneous emission (ASE) reduces the received signal-to-noise ratio and may introduce severe measurement errors.

b) Some traditional dispersion measurement methods require bi-directional transmission. An optical amplifier however, contains optical isolators prohibiting bidirectional transmission of probe or reference signals.

c) In agile networks, end-to-end physical routes (paths) are dynamically set-up and removed arbitrarily (based on users' requests) without interruption of the co-propagating traffic. Agility requires accurate knowledge of the link parameters, which include end-to-end (link) dispersion, since matching an end-to-end path to a connection request is based, among other rules, on individual link/path performance. The chances of setting-up a connection along a path increase (and the time-to-service decreases) if the selection process uses accurate path performance parameters.

d) As well, the current dispersion measurement methods may not be able to cope with the bandwidth-limiting effects introduced by spectral filters in end-to end links.

There is a need to provide a method for measuring dispersion of an end-to-end link of an optical network, that is reliable and inexpensive.

### SUMMARY OF THE INVENTION

It is an object of the present invention to provide a dispersion measurement method and arrangement that alleviates totally or in part the drawbacks of the prior art dispersion measurement methods.

It is another object of the invention to provide a method for measuring dispersion in D/WDM networks that is reliable, accurate and inexpensive.

Another object of the invention is to provide a dispersion measurement card that can be inserted at all optical amplifiers and switching nodes of a communication network to provide an accurate measurement of the dispersion.

Accordingly, the invention provides a method for measuring dispersion of an optical link of an optical network comprising: generating at a transmit end of a link under test LUT, a two-color signal of a first and a second wavelength, each modulated with a digital signal, and transmitting same over the LUT; changing the second wavelength with respect to the first wavelength with a detuning value to impose a known delay between the digital signal carried by the first wavelength and the digital signal carried by the second wavelength; and measuring the BER of the two-color signal for a plurality of detuning values to obtain a BER response.

According to another aspect of the invention, there is provided a dispersion measurement apparatus comprising: a transmitter unit for generating a two-color signal and transmitting same over a link under test; a receiver for detecting a combined electrical signal from the two-color optical signal and measuring the BER of the combined electrical signal; and a dispersion calculating unit for determining the dispersion of the link under test.

Since an end-to-end connection is determined in an agile network after equipment deployment, wavelength switched systems may use measured data, such as link dispersion information, to independently engineer each end-to-end path. Experimental evidence shows that use of measured as opposed to estimated data results in a much better path-connection matching, and could increase the deployed system reach by 50%.

The invention allows to accurately select the fixed dispersion compensating modules DCMs and to adjust the tunable DCMs such that the network reach is optimized for each connection. Thus, the fixed DCMs may be selected in an open loop. Semi-automated closed loop testing can be performed where software selected DCMs are replaced until the target is achieved. Full closed loop adjustment of tunable DCMs (when available) to the link target value may be performed at the switching nodes. Thus, the invention enables auto-optimization of the network since it uses for dispersion measurement the transmission equipment that is already in place.

Another advantage is that accurate measurement of dispersion for each channel along each fiber link increases the likelihood of setting-up a connection along a selected path, resulting in less connection set-up time and thus a faster and less expensive service to the network users. Accurate values for the link dispersion may also be used in selecting the power targets for each wavelength to increase the reach of selected channels based on users' demand.

Also, the method according to the invention can be used in the presence of data traffic in the adjacent channels. It blends in naturally, because the power targets, modulation formats and test signal bandwidth are identical to, or do not exceed the parameter range designed for data carrying signals in the system.

To summarize, using measured dispersion data as in the present invention results in important network cost savings.

### BRIEF DESCRIPTION OF THE DRAWINGS

The foregoing and other objects, features and advantages of the invention will be apparent from the following more particular description of the preferred embodiments, as illustrated in the appended drawings, where:

FIGS. 1A-1C show chromatic dispersion, where FIG. 1A shows the spectral width of a pulse of light; FIG. 1B shows the shape of a data signal at the input to a dispersive fiber link and FIG. 1C shows the same data at the output of the link;

FIG. 2 is a block diagram of a transport link connected in a dispersion measurement arrangement according to an embodiment of the invention;

FIG. 3A shows a plurality of eye diagrams for the two-colour signal obtained from simulations for six detuning values:

FIG. 3B is a BER versus frequency graph illustrating the frequencies regimes corresponding to the eye diagrams of FIG. 3A;

FIG. 4A is a simulated eye diagram for a two-colour NRZ encoded data signal used for dispersion measurement for a mTB and a (m+½)TB differential group delay:

FIG. 4B shows a simulated eye diagram of a two-colour RZ encoded data signal used for dispersion measurement for a mTB and a (m+½)TB differential group delay;

FIG. 5A is a BER-frequency graph (decimal and exponential versions) for an on-grid L-band scan, over a link with a total dispersion DL=25 ps/nm and using a 1:4 power ratio of the two input wavelengths;

FIG. 5B shows the group delay profile deduced from the graphs of FIG. 5A;

FIG. 5C shows the dispersion profile deduced from the graphs of FIG. 5B;

FIG. 6 is a block diagram of a transport link connected in a dispersion measurement arrangement according to another embodiment of the invention;

FIG. 7A shows the BER v. frequency graph generated using a variable ratio between the launch powers of the two input wavelengths; and

FIG. 7B shows BER responses for various launch power ratios extracted from the graph of FIG. 7A.

### DETAILED DESCRIPTION OF THE PREFERRED EMBODIMENTS

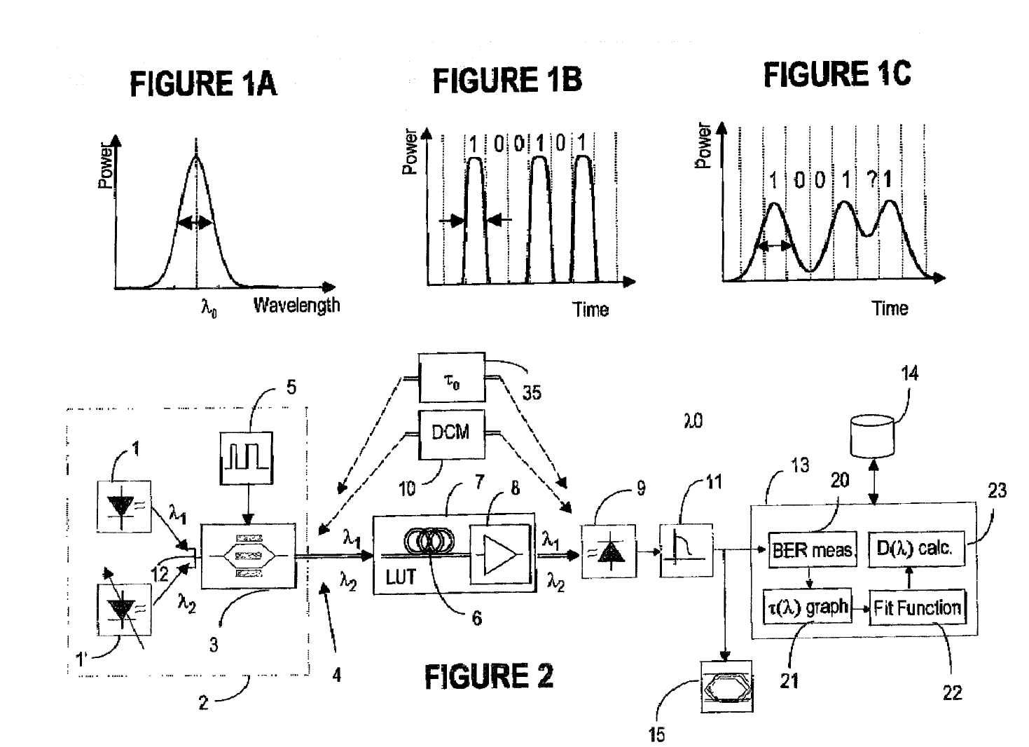

As discussed in the background section, FIGS. 1A-1C show the chromatic dispersion phenomenon. As seen in FIG. 1A a pulse of light has a spectral width, which includes a small range of wavelengths on both sides of the central wavelength λ0. FIG. 1B shows the shape of a data signal ‘100101’ at the input to a dispersive fiber link, and FIG. 1C shows the same data at the output of the link. As indicated above, the pulses broaden as they travel along a dispersive link: the ISI (inter-symbol interference) impacts the quality of reception at the receiver.

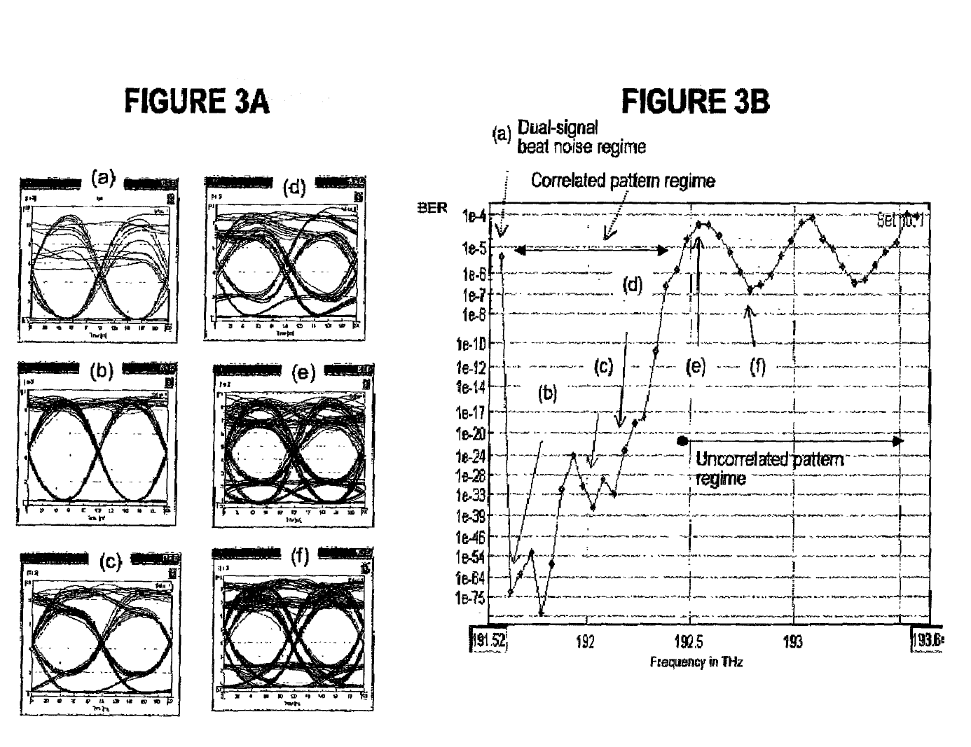

FIG. 2 is a block diagram of an end-to end link between a transmit and a receive node of a WDM network, showing a dispersion measuring arrangement according to an embodiment of the invention. This Figure shows dispersion measurement for forward (West to East) traffic; it is to be noted that similar operations and equipment may be used for measuring dispersion on the reverse links.

An optical transmitter unit 2 located at the transmit node generates a to colour optical signal 4. Transmitter unit 2 comprises a first optical source 1 for generating a first carrier wavelength λ₁ and a second optical source 1′ for generating a second carrier wavelength λ₂. Sources 1, 1′ may be COW laser diodes or the like. The two wavelengths are combined in a modulator 3 so that the bit patterns on both carrier fields are phase-synchronized. The combiner 12 can be any such well known device connected at the input of the modulator 3. The modulator can be a Mach-Zehnder; the modulating signal source is shown at 5. It is to be noted that modulation signal source 5 and modulator 3 may realize any modulation format, amplitude, phase, frequency-shift keying (ASK, PSK, FSK) or any combinations of these.

LUT 7 symbolically represents the link under test. Link 7 includes the fiber 6 and all optical components 8 between the transmitter unit 2 and a far-end receiver 9. Block 8 may include the optical components of the add structure at the transmit node, drop structure at the receive node and the optical components along fiber 6 connecting the two nodes. In general, these are optical active devices, such as optical amplifiers, tunable filters, wavelength selectors/blockers, and optical passive components, such as splices, splitters, connectors, etc. and the transport medium (the fiber).

A single light detector 9 at the output of LUT 7 recovers the electrical signals carried by the two wavelengths. The optical detector 9 may be a broadband receiver (i.e. is not wavelength-specific). Such as a PIN photodetector as well known in the art. The detected photocurrent is then low-pass filtered, as shown at 11. Alternatively, a modulated broadband source could be used with a tunable dual wavelength filter at the receiver. Other variants can also be envisaged.

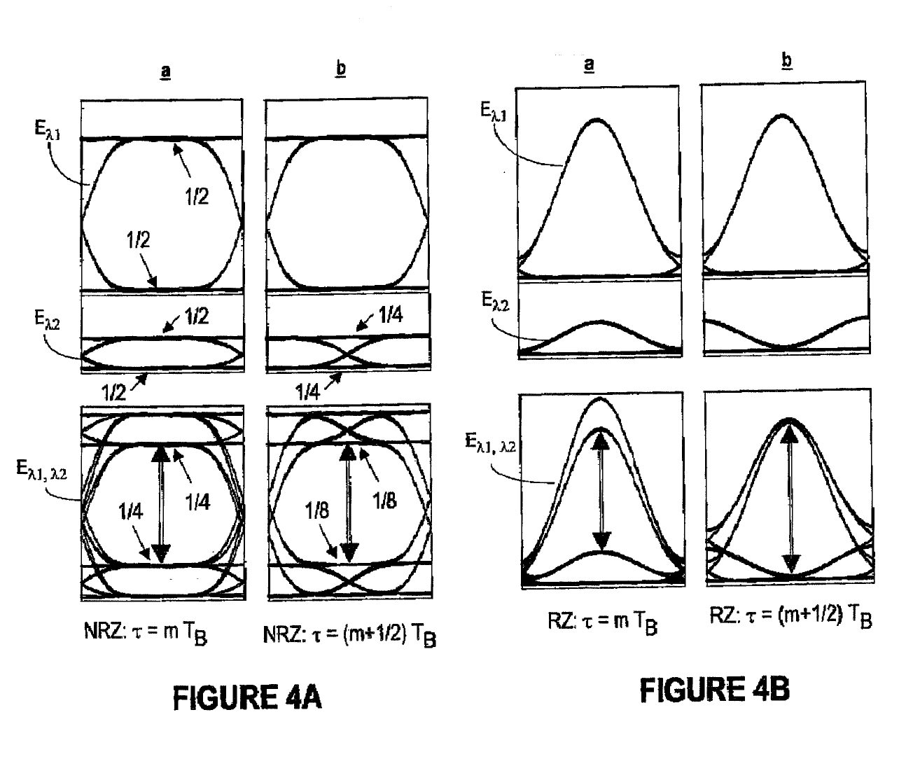

The detected signal is provided to a dispersion calculating block 13 described next in connection with FIGS. 3A, 3B, 4A, 4B, and 5A, 5B, 5C. Optionally, the eye diagram of the two-colour signal can be viewed, as shown at 15.

It is to be noted that transmitters 1 and 1′ and receiver 9 could be equipment physically connected in the network and that the dispersion measurement may be performed on-line or off-line. In general, agile networks have at each/some switching nodes a number of idle transmitters and receivers, ready to be allocated to a new connection or just released from a removed connection. Thus, on-line dispersion measurement could be performed using two free transmitters at one end of the link and a free receiver at the other end. It is also to be noted that the drop structure of such agile networks may use a tunable filter in front of each receiver to select the channel assigned to that receiver for a certain connection. For dispersion measurement, the tunable filter is excluded from LUT 7.

First, a BER measuring unit shown at 20 in FIG. 2 measures the BER of the two-colour signal using any known methods. FIG. 3A shows a plurality of eye diagrams of the two-colour signal for six detuning values, and FIG. 3B is a BER versus frequency graph illustrating the frequencies regimes corresponding to the eye diagrams of FIG. 3A.

The diagrams were obtained using two CW lasers 1, 1′ combined with a 3-dB coupler at the input of modulator 3. Laser 1 emits λ1 with a frequency of 191.583 THz (L-band) at a launch power of 1 mW. Laser 1′ emits wavelength λ0 at a launch power of 0.25 mW, with the frequency increasing from 191.583 THz in increments of 50 GHz. Both lasers have a 10 MHz line width. Signal generator 5 generates a 10-Gb/s NRZ signal (T_{B}=100 s), which is modulated onto the combined fields by modulator 3. After linear propagation through the 500-km LUT 7 with a residual dispersion of 0.05 ps/(nm km) and a zero dispersion slope, receiver 9 detects the superimposed fields and the eye of the two-colour signal is evaluated. The receiver bandwidth is 7 GH. The BER response and the eye diagrams are recorded as a function of the wavelength λ2 of laser 1′.

Three distinct frequency regimes can be identified on the BER graph as follows;

1) Around zero detuning, the eye exhibits large power fluctuations on the upper traces, which lead to a significant eye closure, as shown by eye a. The superposition of the two laser fields (10 MHz line width) produces amplitude fluctuations within the receiver bandwidth (7 GHz). As expected, the fluctuations disappear and the eye opens up when the detuning is greater than the detector bandwidth. Therefore, the narrow 7-GHz regime may be called dual-signal-beat-noise regime.

2) Between 50 GHz and 600 GHz the eye is wide open as shown by eye diagrams b, c and d. In this regime the dual signal beat noise is eliminated, and the differential group delay is still within a bit period T_{B}. Therefore the received patterns are correlated. The intensities of the two signals add coherently, but their fields add incoherently, thus keeping the eye open. Therefore, this regime may be called the correlated-pattern regime.

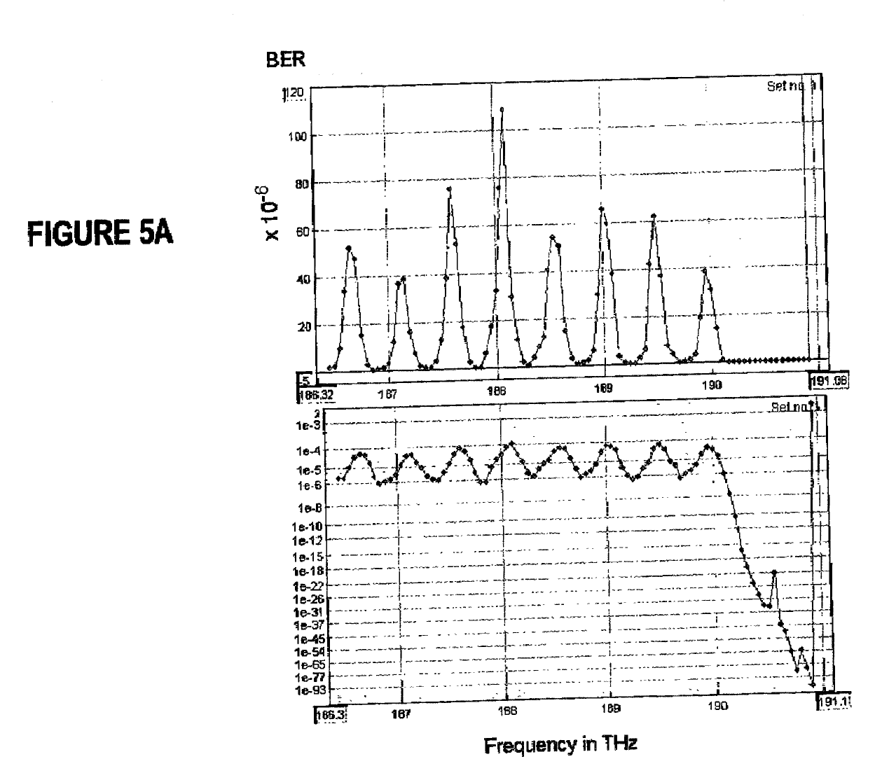

3) For a detuning value larger than 800 GHz, the BER becomes an oscillating function of the detuning, shown by eyes e and f. The eye opening varies with the relative group delay of two uncorrelated patterns; therefore this regime may be called the uncorrelated-pattern regime. The eye closes due to the twin-wavelength inter-symbol interference (ISI) in the two-colour signal when the differential group delay becomes close to integer values of a bit period τ=mTB. The eye opens for a half-period superposition of the two signals τ=(m+½)TB. This regime is better seen in FIGS. 4A and 4B.

FIG. 4A shows a simulated eye diagram of a two-colour NRZ encoded data signal used for dispersion measurement, and FIG. 4B shows a similar simulation for a RZ data signal. For each of FIGS. 4A and 4B, simulation a shows the eyes for a mTB differential group delay, and simulation b shows the eyes for a (m+½)TB differential group delay, the two signals having the same bit period TB, but different powers. The upper part of each graph shows the eye of the first data signal Eλ1, the middle part shows the second data signal E_{λ}2, while the lower part shows the eye of the two-color signal denoted with Eλ1, λ2.

As seen in FIGS. 4A and 4B, if the power ratio of the two wavelengths is chosen such that the weaker field modulates the eye of the stronger field, a periodic eye closure is obtained. Due to the periodically changing statistical weight of various power levels in the NRZ modulation format (between p=½ for the two levels at the center of the bit period, and p=¼ for the four distinct levels near the bit period boundaries), the BER of the combined eye is higher whenever the DGD (differential group delay) is multiples of bit period (p=¼), and lower in-between (p=⅛), even though the geometric noise-free eye opening does not change for NRZ signals. The maximum BER is obtained for detuning values that produce a τ=mTB and the minimium BER is obtained for detuning that produce τ≦(m+½)TB, where m is an integer value.

It should be noted that for an RZ signal, shown in FIG. 4B, a periodic geometric eye opening is actually observed, which enhances the undulation of the BER for various DGDs.

In both cases, the BER changes periodically for increasing frequency offsets, with a period equal to the bit period group delay.

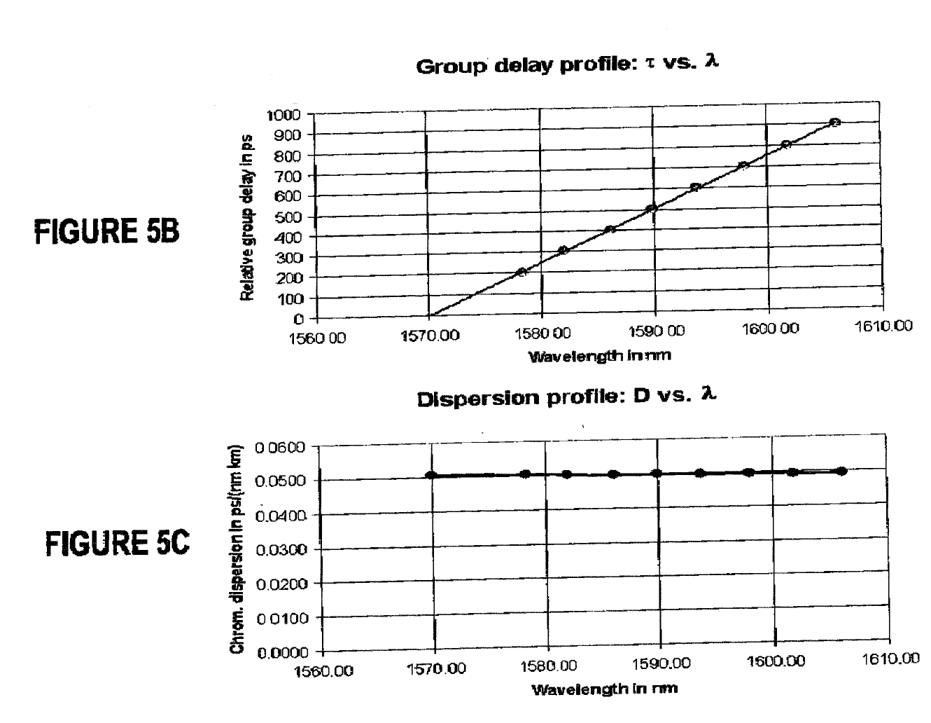

A numerical experiment is provided next for illustrating the dispersion measurement. FIG. 5A shows a BER versus frequency graph for the L band, using one laser with fixed wavelength λ1 of 1570.0 nm (190.95 THz) and a tunable laser of wavelength λ2 that is tuned in steps of 50 GHz (0.42 nm) over 90 channels (4.5 THz) to 1607.9 nm (186.45 THz). It is apparent that the succession of maximums-minimums of eye closures (or openings) result in an undulating BER response. In FIG. 5A, the first BER peak appears for a relative group delay of τ₂=2 T_{B}. The next peaks are due to group delays of τₘ=mT_{B}.

The periodic eye closure may be expressed as in EQ4:

BER(τ)=BER(τ+TB) EQ4

The magnitude of the relative group delay can therefore be inferred from the undulated BER response as a function of the wavelength detuning. FIG. 5B shows the group delay profile τ(λ) deduced from the graphs of FIG. 5A.

Returning now to FIG. 2, the BER measuring unit 20 of dispersion calculating block 13 provides a BER response based on BER measurements for various detuning. BER measurement unit 20 may be for example a software module, and the BER response refers in this specification to a BER graph and/or its key features (minima and maxima in the uncorrelated pattern regime, correlated pattern regime). The BER response is preferably stored in unit 14, in the form of a BER graph, or/and its key features.

The BER response may be used to give feedback to wavelength and power ratio adjustments for optimizing the dispersion measurement accuracy, range and speed. It is possible for example to select a BER maximum in a region of interest, and to take more measurements for certain frequencies in the vicinity of the maximum.

Block 13 also includes group delay profile calculating unit 21, which calculates τ(λ) from the BER response. Unit 21 may again be a software module, which determines the relative group delay as a function of wavelength, using the BER response measured by unit 20.

FIG. 5C shows the dispersion profile versus wavelength D(λ), calculated as in EQ1 from a fit for the τ(λ) dependency of FIG. 5B. A second order polynomial fit for the τ(λ) dependency can be determined from FIG. 5B. FIG. 2 shows generically block 22 that determines a, b and c from τ(λ) graph 20. Block 20 can be again a software module:

τ(λ)=a+b(λ−λ_{ref})+c(λ−λ_{ref})² EQ5

Arbitrarily choosing a reference wavelength of λref=1569.99 nm, the resulting parameters are a=−3.0182 ps, b=25.178 ps/nm, and c=−0.0029 ps/nm² after a 4% error due to polarization mode dispersion (PMD) has been added to the group delay.

Alternatively, the three or five-term Sellmeier equation is used for curve fitting of τ(λ), as discussed in e.g. the book “Fiber Optic Test and Measurement” edited by Dennis Derickson (Prentice Hall, New Jersey, 1998), pages 479-487.

The term “fit function” is used for defining the second order polynomial, the three or five-term Sellmeier equation, or other alternative means expressing the group delay profile shown in FIG. 5B.

Dispersion measurement unit 13 also includes a block 23, which calculates dispersion D and dispersion slope S using EQ6 and the definitions of D and S given by EQ1, and EQ2, respectively. For a particular example where L=500 km:

$$\begin{matrix}D = \frac{1}{L} [ b + 2 c ( λ - {λ}_{ref} ) ] = 0.050 \frac{ps}{nm \cdot km} - ( λ - {λ}_{ref} ) \cdot 1.16 \cdot {10}^{- 5} \frac{ps}{{nm}^{2} km} \\ S = \frac{2 c}{L} = - 1.16 \cdot {10}^{- 5} \frac{ps}{{nm}^{2} km} \end{matrix} \qquad EQ 6$$

The input D value used in the simulation was 0.05 ps/(nm km) with no slope. The extracted D shows good agreement with the input D.

Tables with group delay values extracted from the BER-frequency graphs, and also including the grid wavelengths or interpolated wavelengths closest to the BER peaks can be provided using this method, so that performance of each wavelength on a certain link is known in advance. As indicated above, the data may be for example stored in a memory 14 for use by dispersion measurement unit 13. This data may be used for tuning the link dispersion to the target value during SLAT (system line-up and test), for determining the value of the fixed dispersion compensating modules inserted at the optical amplification sites, etc. The measured dispersion date can also be used in agile networks for mapping a wavelength to a connection during path selection process.

Basically, a two-colour scheme takes advantage of a stronger distortion effect by probing the chromatic dispersion with a larger bandwidth Δλ(0.42 nm)×(number of channels). As shown below, the measurement of inter-band group delay can therefore be approximately 100 times more sensitive as compared to a dispersion measurement scheme that uses a limited single-channel bandwidth

$$\frac{Δ {λ}_{band}}{δ {λ}_{channel}} = number of channels ≅ 100$$

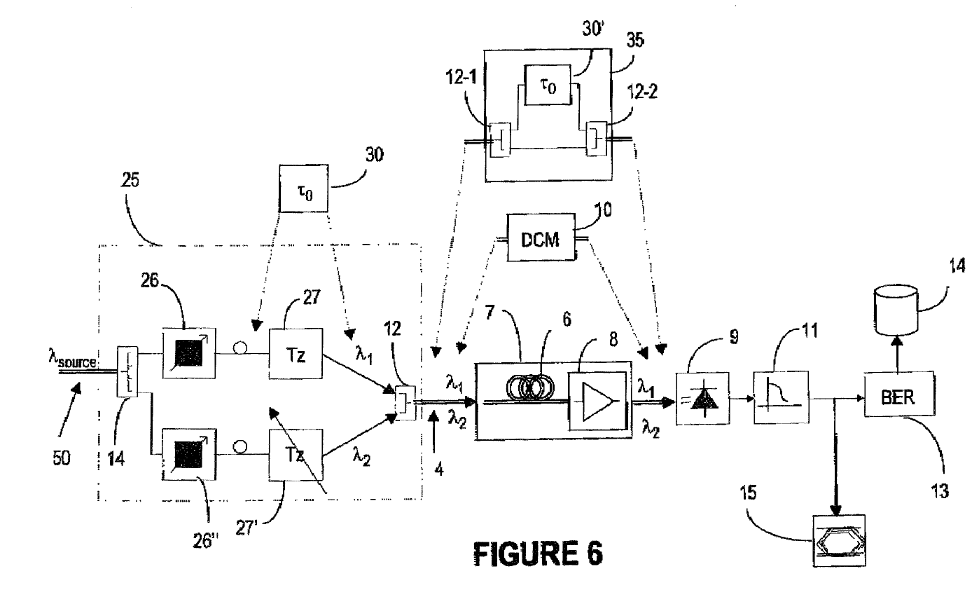

FIG. 6 shows a transmitter unit 20 comprising two transceivers 27 and 27′, operating in a regenerator mode. Namely, the transceivers receive the same input signal on a unique wavelength λsource, recover the data signal carried by the λsource, and modulate it over a respective different carrier wavelength λ1 and λ2. The two wavelengths so modulated are combined in combiner 12 to give the two-colour signal 4. In this way, both signals are phase synchronized at the transmit end and have τ=0.

The remainder of the arrangement is as in FIG. 2.

So far, the sign of the dispersion has been guessed because no information was available whenever the LUT 7 produced a positive or negative DGD τ₁₂=τ₁−T₂=τ_{LUT} between reference λ1 and probe λ1 wavelengths. In many cases, either the sign of the dispersion is known and only the magnitude needs to be determined precisely, or the sign is not known and the magnitude needs to be compensated to zero dispersion. However, if the sign of the chromatic dispersion needs to be determined, this can be accomplished in two ways with an additional differential group delay in the system.

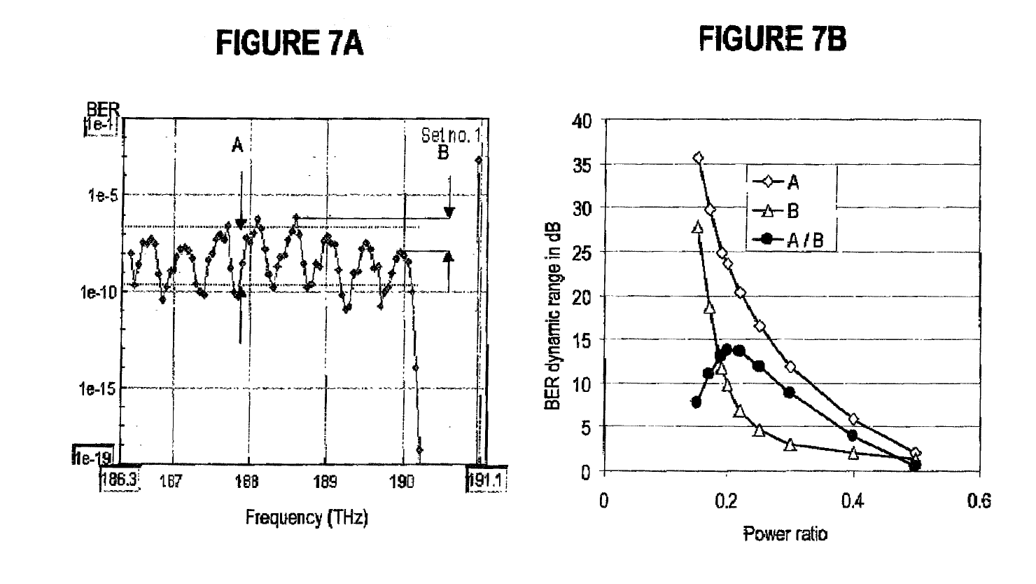

1) Both wavelengths are transmitted through a dispersion pre/post compensating (or enhancing) module DCM 10 as shown in FIGS. 2 and 7 with a known dispersion D₀L₀ and/or dispersion slope S₀L₀ at some wavelength λ₀. The result of the measurement with the DCM 10 is compared to the dispersion measurement of LUT 7 without the additional module. The DGD with the module 10 becomes τ′₁₂=τ′₁−τ′₂=τ_{LUT}+τ_{DCM}, which enhances or reduces the total dispersion depending on the signs of the dispersion of the LUT 7 and of the additional DCM 10. The change in DGD due to the DCM 10 is:

$${τ}_{DCM} = {D}_{0} {L}_{0} ( {λ}_{1} - {λ}_{2} ) + {S}_{p} {L}_{0} [ \frac{( {λ}_{1} + {λ}_{2} )}{2} - {λ}_{0} ] ( {λ}_{1} - {λ}_{2} ) \qquad EQ 7$$

2) Only one wavelength PRBS is delayed optically as shown 35 in FIGS. 2 and 6, by a fixed value τ₀. Block 35, shown in detail in FIG. 6, comprises in input demultiplexer 12-1 and an output demultiplexer 12-2. The delmultiplexer separate/combines, let's say wavelength λ1, from/into the WDM signal. The unit 30′ delays the respective wavelength with τ₀.

As seen on the BER plot of FIG. 3B, the remarkable dip in the BER due to the correlated pattern effect appears when the differential group delay is less than 2 bit periods, i.e. when the two PRBS intensities add coherently at λ₁≈λ₂ such that:

|(λ₁−λ₂)·(DL)_{LUT}|=|τ_{LUT}|≦TB. EQ8

With the extra group delay τ₀ introduced in one of the two carriers, the distinguished BER dip in the correlated pattern regime appears when the two PRBS add coherently at some λ_{1≠λ}₂, i.e. when the BER is minimized by;

|(λ₁−λ₂)(DL)_{LUT}+τ₀|=|τ_{LUT}+τ0|≦T_{B}. EQ9

which implies that,

−T_{B}−τ₀≦τ_{LUT}≦T_{B}−τ₀. EQ10

The sign of the τ_{LUT} can now be determined from the sign of τ₀.

Since in the embodiment of FIG. 6, the two-color signal is obtained by combining two optical signals generated with two different transceivers, it is possible to delay one of the signals with τ at the transmitter, as shown by the delay block 30. In this case, the delay can be imposed on the respective signal in optical or electrical format.

In fact, a single fixed wavelength setting λ₁≠λ₂ is sufficient to determine the magnitude and sign of the LUT differential group delay in each above methods 1) and 2) if the extra group delay τ_{DGM} or τ₀ is not fixed, but can be tuned to minimize the BER in the correlated pattern regime which is observed at zero differential group delay.

As indicated in connection with FIGS. 4A and 4B, the BER response is very sensitive to power and noise variations. In particular, the ratio of the powers used in the two wavelength detection scheme can be optimized for each modulation format (erg. RZ or NRZ), filter bandwidth and eye distortion. FIG. 7A shows a typical BER v. frequency response for a 0.19 ratio between the launch powers of the two wavelengths.

It has been noted that a variation in the BER peak values does not affect the measurement if this variation is smaller than the total minimum-to-maximum BER variation. FIG. 7B shows a BER v. power ratio graph corresponding to the graphs of FIG. 7A. The maximum-to-minimum dynamic BER range (A) shown in the graph is compared to the dynamic range of BER peaks (B). The ratio A/B (for linear A and B) is the dynamic range left for the peak detection. In case of a small perturbation of the eye with the second signal (low power ratios, near 0.1), the BER peak values scatter too much. Towards larger power ratios, near 0.5, the BER response smoothens out and the undulation disappears faster than the peak variations. The optimum power ratio for the simulated 500 m 10 GB/s NRZ transmission link is near P(λ₁)/P(λ₂)=0.2, yielding a dynamic reserve of (A/B)_{dB}=13.8 dB.

The optimum power ratio and dynamic reserve depends on the particular modulation format dispersion map, nonlinear distortion and optical-to-noise ratio (OSNR). These parameters change the eye shape and eye opening to which the detected BER is very sensitive. Furthermore, a fast dispersion measurement requires a higher BER to reduce the sampling time at each detuning of the wavelength. This condition also changes the desired power ratio. The purpose of the previous analysis was to show that an optimum ratio actually exists and that a large dynamic reserve can be achieved for a likely dispersion measurement scenario. It is also possible to speed-up the measurement if the number of errors in the link is increased.

It has been evaluated that the accuracy of the two-colour dispersion measurement method is better than 1%. The range of dispersion measurement is 5 ps/nm<DL<230 ps/nm for a 10 Gbs NRZ transmitter/receiver, 35 nm total bandwidth and 50 GHz channel spacing.

The clock synchronization of the two signals can also be achieved using a regenerator-assisted signal duplication as shown in FIG. 6.

It is also possible to design a dispersion measurement card and use a pair of such cards for span-by-span measurement of dispersion. The card may be designed to perform measurements on all lines at the respective node. It has a size selected to fit into a respective rack, and a standard physical interface with the rack backplane. This is possible in an agile network which uses standard backplanes for all racks.

As indicated above, the measurements may be performed in this case off line or on line. In the case of off line measurements, the frequency is swiped along the respective band (C, L, or the like) in increments according to the ITU grid used in the network (100 GHz, 50 GHz, 25 GHz). The dispersion data is used e.g. for selecting the fixed DGMs provided at the optical amplification sites, to adjust the link dispersion to the target value for ULR. The measurements are further stored in tables for future use by the tunable DCMs provided at the switching nodes and by the routing and switching mechanism in the path selection process. A pair of cards may be moved from site to site if the cost of providing such cards at each node is of concern.

In the case that the measurement is performed on line, as discussed above, selection of wavelengths λ1 and λ2 takes into account the wavelengths that are currently in use on the respective link. However, as the measured data are recorded, and the wavelength configuration on the link changes, the measurement for all wavelengths will be obtained after a certain time.

We claim:

1. A method for measuring dispersion of an optical link between two nodes of an optical network comprising:
at a transmit end of a link under test LUT, generating a two-color signal of a first and a second wavelength, each modulated with a digital signal, and transmitting same over said LUT;
changing said second wavelength with respect to said first wavelength with a detuning value to impose a known delay between said digital signal carried by said first wavelength and said digital signal carried by said second wavelength; and
measuring the BER of said two-color signal for a plurality of detuning values to obtain a BER response.

2. A method as claimed in claim 1, further comprising determining the dispersion of said LUT from said BER response.

3. A method as claimed in claim 1, wherein said step of changing comprises maintaining said first wavelength constant and changing said second wavelength with said detuning values.

4. A method as claimed in claim 1, wherein said step of transmitting comprises in-phase modulating each said first and said second wavelength with said digital signal.

5. A method as claimed in claim 3, wherein said step of in-phase modulating comprises:
combining said first and said second wavelengths at the input of a modulator to obtain a combined optical signal; and
modulating said digital signal over said combined optical signal using said modulator.

6. A method as claimed in claim 1, wherein said step of generating further comprises, for a selected detuning value, changing the ratio between the launch powers of said first and second wavelengths to obtain a minimum BER.

7. A method as claimed in claim 2, wherein said step of determining the dispersion of said LUT comprises:
identifying from said BER response an uncorrelated-pattern regime defined by BER(τ)=BER(τ+TB), where τ is the group delay and TB is the bit period of said digital signal; and
determining the relative group delay from said BER response for a plurality of detunings between said first and said second wavelengths.

8. A method as claimed in claim 2, wherein said step of determining the dispersion of said LUT comprises
from said BER response, establishing a group delay response τ(λ);
determining a fit function which characterizes best said group delay response τ(λ) for said LUT;
choosing an arbitrary reference wavelength λ_{ref} for determining the parameters of said fit function fit; and
determining the dispersion of said LUT from said second order polynomial fit.

9. A method as claimed in claim 2, further comprising determining the sign of dispersion.

10. A method as claimed in claim 2, further comprising:
inserting into said LUT a module with a known dispersion;
determining the dispersion of said two-color signal for a detuning value when said LUT includes said module; and
determining the sign of dispersion by comparing the dispersion of said LUT with and without said module.

11. A method as claimed in claim 2, further comprising:
delaying said digital signal modulated over said first wavelength by a fixed delay value τ₀;
identifying from said BER response a correlated-pattern regime where the differential group delay τ is less than two bit periods TB; and
determining the sign of the dispersion from the sign on said fixed value.

12. A method as claimed in claim 11, wherein said fixed delay value is applied to said digital signal in one of the electrical and optical formats.

13. A dispersion measurement apparatus comprising:
a transmitter unit for generating a two-color signal and transmitting same over a link under test LUT;
a receiver for detecting a combined electrical signal from said two-color optical signal and measuring the BER of said combined electrical signal; and
a dispersion calculating unit for determining the dispersion of said LUT.

14. A dispersion measurement unit as claimed in claim 13, wherein said transmitter unit comprises:
a first and a second transmitter, each for generating a respective first and second wavelength;
means for combining said first and said second wavelengths into a combined optical signal; and
an optical modulator, for modulating a digital signal over said combined optical signal to provide a two-color signal.

15. A dispersion measurement unit as claimed in claim 14, wherein said second transmitter is a tunable transmitter for changing said second wavelength to vary the BER of said combined electrical signal.

16. A dispersion measurement unit as claimed in claim 13, wherein said dispersion calculating unit comprises means for generating a BER response including a plurality of BER values measured for a plurality of values of said second wavelength.

17. An apparatus as claimed in claim 16, wherein said dispersion calculating unit further comprises:
means for constructing a group delay response τ(λ) from said BER response;
means for determining, on said τ(λ) response, a fit function for said LUT and calculating the parameters of said fit function for an arbitrary reference wavelength λ_{ref};
means for determining the dispersion of said LUT from said fit function.

18. An apparatus as claimed in claim 16, further comprising memory means for storing said BER response.

19. An apparatus as claimed in claim 17, further comprising a memory for storing BER response, said group delay response, and said fit function.
